(19) United States
(12) Patent Application Publication
(10) Pub. No.: US 2009/0006190 A1
(43) Pub. Date: Jan. 1, 2009

(54) DETERMINING LOCATION-BASED COMMERCIAL INFORMATION

(75) Inventors: Nathan Lucash, San Francisco, CA (US); Shuman Ghosemajumder, Palo Alto, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/770,579

(22) Filed: Jun. 28, 2007

(51) Int. Cl. G06Q 30/00; G06Q 10/00

(52) U.S. Cl. 705/14

(57) ABSTRACT

Techniques for determining location-based commercial information are described The techniques include receiving a request for an advertisement to be presented together with content provided over a delivery network to a recipient, performing a process to identify advertisement information to be presented based on the content, and if advertisement information is not identified by the process, identifying commercial information to be presented based an geographic location of the recipient and communicating over the delivery network, the identified commercial information to the recipient.

### TECHNICAL FIELD

This disclosure is generally related to online advertising.

### BACKGROUND

Interactive media (e.g., the Internet) has great potential for improving the targeting of advertisements (“ads”) to receptive audiences. Ads can be presented as banner ads, sets of one or more text boxes, video ads, audio ads, and the like. For example, some websites provide information search functionality that is based on keywords entered by the user seeking information. This user query can be an indicator of the type of information of interest to the user. By comparing the user query to a list of keywords specified by an advertiser, it is possible to provide targeted ads to the user. An example of such a system is AdWords™ offered by Google Inc. (Mountain View, Calif.).

Another form of online advertising is ad syndication, which allows advertisers to extend their marketing reach by distributing contextual ads to additional partners. For example, third party online publishers can place an advertiser's text or image ads on web properties with desirable content to drive online customers to the advertiser's website. An example of such a system is AdSense™ offered by Google Inc.

In contextual advertising systems (e.g., AdSense™), ads are selected and served by automated systems based on the content displayed by the user in, for example, a browser window. The displayed content is analyzed to determine the “context” of the page (e.g., the main topic), so that ads that best match the context can be targeted to the webpage. In contextual advertising systems such as AdSense, once the context of a content page is matched to a set of potential advertisements for display, an auction mechanism is used to select one or more potential advertisements to actually appear on the page. In this manner, a small subset of advertisements that can potentially appear on any particular relevant content page actually do appear on each webpage.

When a member of the advertising audience (hereinafter referred to as a “viewer” or “user” without loss of generality) views one of the ads (such as when a page of content including the ad is displayed and/or rendered to the audience member), that is deemed to be an “impression” of the ad. When a user selects one of these ads by clicking on it, embedded hypertext links, executable code, and the like, typically direct the viewer to the advertiser's Web site or the advertiser's online or real world presence. This process, wherein the viewer selects an ad, is commonly referred to as a “click-through” (“Click-through” is intended to cover any user selection.). The ratio of the number of click throughs to the number of impressions of the ad (i.e., the number of times an ad is displayed) is commonly referred to as the “click-through rate” (CTR) of the ad. A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Alternatively, a conversion may be defined as a user being shown an ad, and making a purchase on the advertiser's web page within a predetermined time (e.g., seven days). Many other definitions of what constitutes a conversion are possible. The ratio of the number of conversions to the number of impressions of the ad (i.e., the number of times an ad is displayed) is commonly referred to as the conversion rate.

In some online advertising systems, advertisers pay for their ads through an advertising auction system in which they bid on advertisement placement on a Cost-Per-Click (CPC) or a Cost-Per-Mille (e.g., thousand impressions) (CPM) basis. The advertiser typically has a budget to spend on advertising, and the auction can be run between competing advertisers via each bidders CPC and/or CPM bid given the advertiser's budget, or through a more complex equation of CPC and CPM, such as one that weighs the advertiser's bid by that advertisement's known Click-Thru-Rate (CTR) or other values. In one variation on the system, an advertiser targets an advertisement at a particular content location, web site, or content category, and the advertiser's bid is weighted by an estimated Click Through Rate (eCTR).

### SUMMARY

In one general aspect, a request for an advertisement to be presented together with content provided over a delivery network to a recipient is received. A process is performed to identify advertisement information to be presented based on the content. If advertisement information is not identified by the process, commercial information to be presented is identified based on geographic location of the recipient and the identified commercial information is communicated to the recipient over the delivery network.

Implementations may include one or more of the following features. For example, the commercial information may include text identifying subject matter relevant to the geographic location. An option for navigating to one or more advertisements related to the text may be provided. An option for navigating from one advertisement of the one or more advertisements to content provided by the sponsor of the one advertisement may be provided. The commercial information may include an advertisement related to the geographic location. Performing a process to identify advertisement information to be presented based on the content may include evaluating advertiser bids for placement with content.

The geographic location of the recipient may be determined based on an IP address or information directly entered by the recipient. The geographic location of the recipient also may be determined by inferring a geographic location from search activity of the recipient or from browsing activity of the recipient. The delivery network may include at least one of a computer network, a telephone network and a broadcast network.

In another general aspect, a request for one or more content items to be presented together with other content provided over a delivery network to a recipient is received. An attempt is made to identify one or more content items of a first type based on the other content. If the attempt falls, one or more content items of a second type are identified, based on a geographic location of the recipient and the identified one or more items are communicated to the recipient over the delivery network. Implementations may include one or more of the features noted above.

The details of one or more implementations are set forth in the accompanying drawings and the description below. Other features and advantages will be apparent from the description and drawings as well as from the claims.

### BRIEF DESCRIPTION OF THE DRAWINGS

FIG. 1 is a block diagram depicting an example advertising environment.

FIG. 2 is a diagram illustrating an example data flow within an advertising environment.

FIG. 3 is a block diagram of an example ad targeting system.

FIG. 4 is a flow diagram of an example ad targeting process.

FIG. 5 is a diagram of example user interfaces in an on-line advertising system.

FIG. 6 is a block diagram of an example system architecture for an ad targeting system.

Like reference numbers and designations in the various drawings indicate like elements.

### DETAILED DESCRIPTION

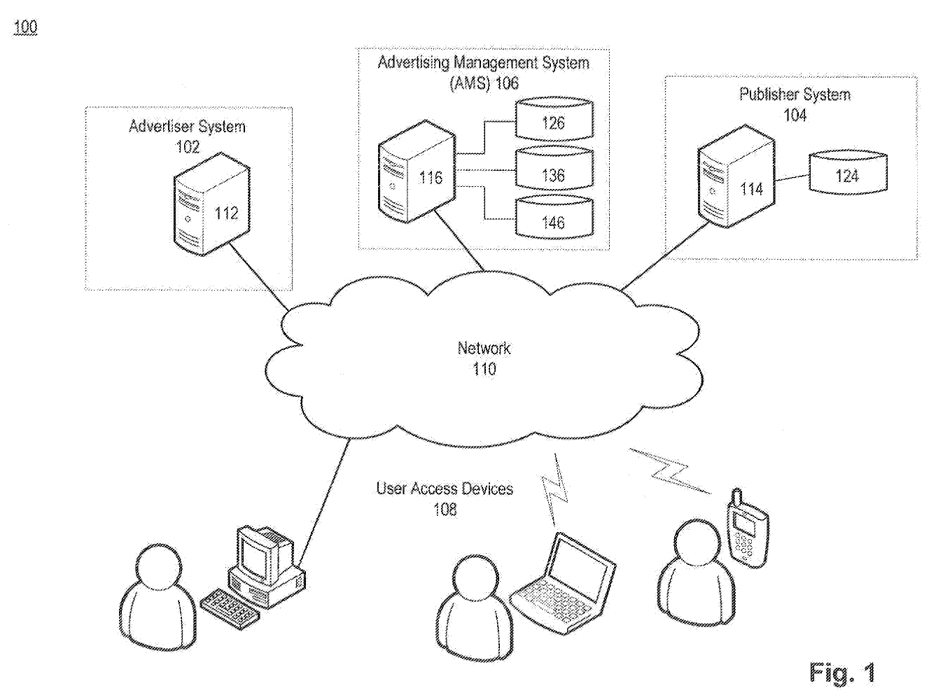

FIG. 1 is a block diagram illustrating an example advertising environment 100 configures to present location-based commercial information in lieu of on-line advertisements. The environment 100 includes an advertiser system 102 (hereinafter referred to as the advertiser 102), a publisher system 104 (hereinafter referred to as the publisher 104), an ad management system (AMS) 106, and one or more user across devices 108, which may be coupled to a network 110. For brevity, only one advertiser system 102 and one publisher system are illustrated. In some examples, each of the elements 102, 104, 106, 108 and 110 may be implemented or associated with hardware components. The elements 102, 104, 106, 108 and 110 could, for example, be implemented or associated with general purpose servers, software processes and engines, and/or various embedded systems.

The advertiser 102 is operated by and represents an entity that is associated with advertisements (“ads”). An advertisement or an “ad” refers to any form of communication in which one or more products, services, ideas, people, organizations or other items are identified and promoted. Ads may be communicated via various mediums and in various forms. In some examples, ads may be communicated through an interactive medium, such as the Internet, and may include graphical ads (e.g., banner ads), textual ads, image ads, audio ads, video, ads, ads combining one or more of any such components, or any form of electronically delivered advertisement. Ads may include embedded information, such as embedded media, links, meta-information, and/or machine executable instructions. Ads may also he communicated through RSS (Really Simple Syndication) feeds, radio channels, television channels, telephone networks, print media, and other media.

In some implementations, the advertiser 102 provides (or be otherwise associated with) products and/or services related to ads. The advertiser 102 may include or be associated with, for example, retailers, wholesalers, warehouses, manufacturers, distributors, health care providers, educational establishments, financial establishments, technology providers, energy providers, utility providers, or any other product or service providers.

The advertiser 102 directly or indirectly generates, maintains and/or tracks ads, which may he related to products or services offered by or otherwise associated with the advertisers. The advertiser 102 may include or maintain one or more data processing systems 112, such as servers or embedded systems, coupled to the network 110. The advertiser 102 could include or maintain one or more processes that run on one or more data processing systems.

The publisher 104 is operated by and represents an entity that generates, maintains, provides, presents and/or otherwise processes content in the environment 100. In some implementations, the publisher 104 may include content providers with an Internet presence, such as online publication and news providers (e.g., online newspapers, etc.), online service providers (e.g., financial service providers, health service provider, etc.), and the like. The term “content” refers to various types of web-based and/or other information, such as articles, discussion threads, reports, analyses, financial statements, music, video, graphics, search results, web page listings, information feeds (e.g., RSS feeds), television broadcasts, radio broadcasts, printed publications, etc.

The publisher 104 receives requests from the user access devices 108 (or other elements in the environment 100) and provides or presents content to the requesting devices. The publishers may provide or present content via various mediums and in various forms, including web based and non-web based mediums and forms. The publisher 104 generates and/or maintains such content and/or retrieves the content from other network resources. The publisher 104 is configured to present advertisements together with content and to present location-based commercial information together with content, as described more fully below.

In some implementations, the publisher 104 provides searching services and provides content in the form of search results. A search service can receive queries for search results and retrieve relevant search results from various sources, such as an index of documents (e.g., from an index of web pages). Search results can include, for example, lists of web page titles, snippets of text extracted from those web pages, and hypertext links to those web pages.

In addition to content, the publisher 104 may be configured to integrate or combine retrieved content with ads that are related or relevant to the retrieved content for display to users. These relevant ads may be provided from the AMS 106 and be combined with content for display to users. As described further below, the user access devices 108 could also process ads for display to users. In some examples, the publisher 104 could retrieve an article for display on a particular user access device 108 and then forward the article to the user access device 108 along with code that causes one or more ads from the AMS 106 to be displayed to the user. In other examples, the publisher 104 could retrieve an article, retrieve one or more relevant ads (e.g., from the AMS 106 or the advertiser 102), and then integrate the ads and the article to form a content page for display to the user.

The publisher 104 is configured to integrate or combine retrieved content with location-based commercial information in the event that no ads are related or relevant to the retrieved content for display to users. The location-based commercial information may be provided from the AMS 106 and be combined with content for display to users. Alternatively or additionally, user access devices could process commercial content for display to users and do so in a similar manner as described with respect to ads.

The publisher 104 may include or maintain one or more data processing systems 114, such as servers or embedded systems, coupled to the network 110. They may include or maintain one or more processes that run on data processing systems. In some examples, the publisher 104 may include one or more content repositories 124 for storing content and other information.

The AMS 106 may manage ads and provide various services to the advertisers 102, the publishers 104, and the user access devices 108. The AMS 106 may include one or more data processing systems 116, such as servers or embedded systems, coupled to the network 110.

In some implementations, the AMS 106 may allow elements in environment 100 to store, select and/or retrieve ads for presentation to users. For example, the AMS 106 may facilitate the distribution of ads from the advertiser 102 to the user access devices 108 via the publisher 104. The AMS 106 may also manage and process various agreements and transactions among and between elements in environment 100. For example, the AMS 106 may credit accounts associated with the publisher 104 and debit accounts of the advertiser 102.

The AMS 106 enables the advertiser 102 to directly or indirectly enter, maintain, and track ads for presentation on user access devices 108. In some examples, the ads may be stored in an ad repository 126. The AMS 106 enables the advertiser 102 to select and/or specify new or existing ads as well as conversion types for ads. A “conversion” may occur when a user consummates a transaction related to a given ad. User actions which may be deemed a conversion may vary. For example, a conversion may be defined to occur when a user clicks on an ad, is referred to the advertiser's web page, and consummates a purchase at the advertiser's web site there before leaving that advertiser's web site. In another example, a conversion could be defined as the display of an ad to a user and a corresponding purchase on the advertiser's web page within a predetermined time (e.g., seven days). Different kinds of conversions may be referred to as conversion types. Each conversion type may correspond to a conversion action that a user may perform, such as a purchase of a product or service, a selection of a banner ad (click-through) or other user action. The AMS 106 stores conversion data and other information in a conversion data repository 136.

The AMS 106 may also allow the advertiser 102 to input description information associated with ads. This information could be used to assist the publisher 104 in determining ads to publish. The advertiser 102 may additionally input a cost/value associated with selected conversion types, such as a five dollar credit to the publisher 104 for each product or service purchased.

The AMS 106 provides ads to the publisher 104 and/or the user access devices 108. In some examples, the AMS 106 may send ads to a requesting user device 108 when the user device loads content from a particular publisher 104. The ads can be placed with or embedded in a publisher's content (e.g., videos, articles, etc.), which can be stored in the content repository 124 at the publisher, and/or placed with content received from other sources (e.g., other publishers, advertisers).

The AMS 106 may provide ads to publishers and/or user access devices such that the ads are displayed in ad presentations. An ad presentation may refer to any type of communication or display of one or more ads. The AMS 106 may present ads via various mediums and in various forms, including web based and non-web based mediums and forms. In some examples, ads may be presented in an “ad portion” of a user display. The term “ad portion” refers to any portion (which could include all) of a display in which ads can be situated. The ad portion can be a discrete, isolated portion of a display or it can be blended and dispersed throughout a display.

In some examples, the ad portion may include a portion of a web page or browser display, which also displays content. The ad portion may separate and distinct from other content in the display. For example, the ad portion could be a window or frame that is separate from displayed content. The ad portion could also be integrated and blended with displayed content. For example, the ad portion could include several sub portions dispersed throughout a web page and integrated with displayed content.

The AMS 106 provides location-based commercial information for presentation with content to the publisher 104 and/or the user access devices 108 in the event that no relevant ads are identified for presentation. The location-based commercial information enables a user to access ads relevant to the location of the user. In some implementations, the location-based commercial information are commercial phrases that are presented together with the publisher's content. In one example, location-based commercial phrases for Mountain View, Calif. include Mountain View Florists, Mountain View Doctors, Mountain View Restaurants and Mountain View Attractions, etc. Each of the location-based commercial phrases enables the display of relevant ads. For example, Mountain View Florists may enable display of a list of advertisements for various florists in Mountain View. In another example, location-based commercial information may be ads that are presented with publisher content. In such a case, for example, a list of advertisements for various florists may be presented together with the publisher's content.

The AMS 106 may allow the publisher 104 to search and select specific products and services as well as associated ads to be displayed with content provided by the publisher 104. For example, the publisher 104 could search through ads in the ad repository 126 and select certain ads and block or filter out other ads. In some examples, the AMS 106 may contextually determine or recommend specific items and ads based on, for example, relevance to the publishers site content. The AMS 106 could also determine specific items and ads based on user behaviors, such as particular search queries performed on a search engine website, a geographical location of the user, etc. The AMS 106 could, in some examples, store user-related information (e.g., personal profiles of users, geographic locations of users, ad context information) in a general data repository 146. A combination of these and other approaches could also be used to provide ads to the publisher 104. The ad selections and preferences specified by the publisher 104 can be used by the AMS 106 when it selects ads for display to the user devices 108.

The AMS 106 may be configured to crawl the network 100 to search, identify, index and store content accessible through the network 100. This may be accomplished, for example, by the AMS 106 associating content keywords, another type of classification, or other information with crawled content using various processes and logic. The content keywords may summarize aspects of the content. The AMS 106 may maintain or access an index or listing of identifiers (e.g., Universal Resource Locators (URL) associated with crawled content. The identifiers may be associated with the keywords and/or other classification information. In some implementations, the AMS 106 may include or access a listing of URL-keyword pairings.

Using crawled and indexed network content, the AMS 106 may be configured to identify advertisements in the ad repository 126 relevant to a user's interest. The AMS 106 may be configured to compare information associated with requested content (e.g., URLs) with indexed identifiers associated with crawled content. The AMS 106 may use associated content keywords to identify and retrieve relevant ads. In some implementations, the AMS 106 could receive information (e.g., ad keywords) from the advertiser 102 relevant to the advertisers' products and services, which could be used in identifying relevant ads.

As an example, the AMS 106 can receive a URL of a requested content page (e.g., from the user access device 108 or the publisher 104). The AMS 106 may use the URL to identify the user interest (i.e., the requested content). For example, the AMS 106 matches the URL to indexed content keywords associated with the URL. The AMS 106 then matches the user interest with ads in the repository 126 relevant to the user interest. The AMS 106 may use ad keywords from the advertiser 102 and/or other ad information to identify the ads. In some examples, the AMS 106 could compare ad keywords from the advertiser 102 to content keywords and/or content in the content page to identify relevant ads for presentation with the content.

In some examples, the ad preferences and selections specified by the publisher 104 and/or advertiser 102 may be used in determining relevant ads. For example, the AMS 106 may reject certain ads based on publisher preferences, even though the rejected ads may be relevant to the determined user interest.

In some implementations, the AMS 106 may manage and process financial transactions among and between elements in the environment 100. For example, the AMS 106 may credit accounts associated with the publisher 104 and debit accounts of the advertiser 102. These and other transactions may he based on conversion data, impressions information and/or click-through rates received and maintained by the AMS 106.

The user access devices 108 may include any devices capable of receiving information from the network 110 and displaying or otherwise presenting ads. In some implementations, the user access devices 108 may receive ads and ad related information from the AMS 106 and present the ads (e.g., via a browser or other viewer) to users. The user access devices 108 may combine ads received from the AMS 106 with content received from the publisher 104 or other sources for presentation to users. Additionally or alternatively, the user access devices 108 may receive combined ads and content from the publisher 104 and present (e.g., in a viewer) this information to viewing users.

The user access devices 108 could include general computing components and/or embedded systems optimized with specific components for performing specific tasks. Examples of user systems include personal computers (e.g., desktop computers), mobile computing devices, cell phones, smart phones, media players, media players/recorders, music players, game consoles, media centers, electronic tablets, personal digital assistants (PDAs), television systems, audio systems, removable storage devices, navigation systems and the like.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 could include any number of geographically-dispersed advertiser 102, publisher 104 and/or user access devices 108, which may he discrete, integrated modules or distributed systems. Similarly, the environment 100 is not limited to a single AMS 106 and may include any number of integrated or distributed AMS elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

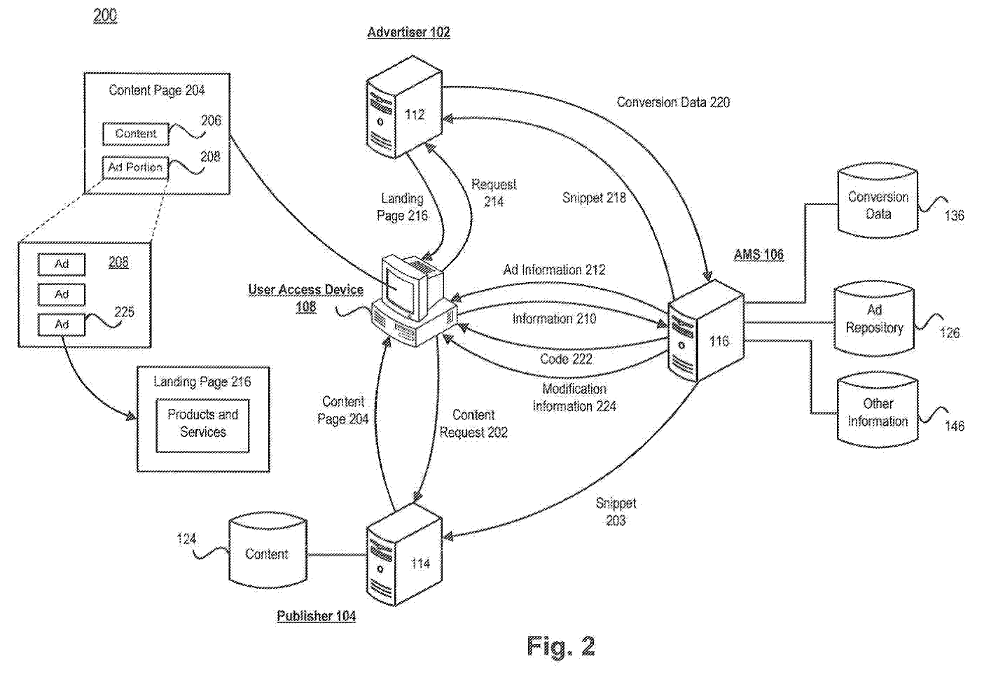

FIG. 2 illustrates an example data flow 200 within the environment 100. The data flow 200 is an example only and not intended to be restrictive. Other data flows may therefore occur in the environment 100 and, even with the data flow 200, the illustrated events and their particular order in time may vary.

In the data flow 200, a particular publisher 104 receives a content request 202 from a particular user access device 108. The content request 202 may, for example, include a request for an article on a given topic (e.g., automobiles). In response to the request 202, the publisher 104 may retrieve relevant content (e.g., an automobile article) from the content repository 124 or some other source.

The publisher 104 responds to the content request 202 by sending a content page 204 or other content presentation to the requesting user device 108. The content page 204 may include the requested content 206 (e.g., the automobile article) as well as a code “snippet” 203 associated with an ad presentation. A code “snippet” refers, for example, to a method used by one device (e.g., a server) to ask another device (e.g., a browser running on a client device) to perform actions after downloading information. In some examples, a code “snippet” may be implemented in JavaScript® code or may be part of HTML (Hypertext Markup Language) or other web page markup language or content.

In some implementations, the AMS 106 may provide the code snippet 203 to the publisher 104 and/or the user access device 108. The code snippet could originate and/or be provided from other sources. As the requesting user device 108 loads the content page 204, the code snippet 203 causes the user device 108 to contact the AMS 106 and receive additional code (e.g., Java Script® or the like), which causes the content page 204 to load with an ad portion 208.

The ad portion 208 may include any element that allows information to be embedded within the content page 204. In some examples, the ad portion 208 may be implemented as an HTML element, such as I-Frame (inline frame) or other type of frame. In some examples, the ad portion 208 may be hosted by the AMS 106 or the publisher 104 and may allow content (e.g., ads) from the AMS 106 or the publisher 104 to be embedded inside the content page 204. Parameters associated with the ad portion 208 (e.g., its size and shape) can be specified in the content page 204 (e.g., in HTML), so that the user access device 108 can present the content page 204 while the ad portion 208 is being loaded. Other implementations of ad portion 208 may also be used.

At this stage in the data flow 200, the ad portion 208 in the content page 204 sends the AMS 106 formatting and content information 210. This information 210 may include information describing the manner (e.g., bow, when, and/or where) in which ads can be rendered by the user access devices 108. The information 210 could include ad attributes and parameters, such as size, shape, color, font, presentation style (e.g., audio, video, graphical textual, etc.), etc. The information 210 may also specify a quantity of ads desired,

The formatting and content information 210 may also include information associated with the content 206 being displayed in content page 204. Such information may include a URL associated with the requested content page 204. In some implementations, the information 210 could include the requested content itself (e.g., web page, content document, etc.) a category corresponding to the requested content or the content request (e.g., automobiles, arts, business, computers, movies, music, etc.) part or all of the content request 202, content page, content type (e.g., text, graphics, video, audio, mixed media, etc.), geo-location information , and the like.

In response to the information 210, the AMS 106 may provide the user access device 108 with ad information or location-based commercial information 212. The ad information 212 may include one or more ads 225 for placement in the ad portion 208 of the content page 204. The ad information 212 sent from the AMS 106 may also include a signed or encoded specification of an ad. In the event that the AMS 106 is unable to identify an ad relevant to the content page 204, the AMS 106 provides location-based commercial information 212. The location-based commercial information 212 may include one or more commercial phrases and/or one or more advertisements relevant to the location of the user to whom the content page 204 is to be presented.

In some implementations, the ad information 212 may include ads that are relevant to the user's interest, as determined by the requested content. The AMS 106 may retrieve and provide relevant ads based on the information 210 received from the user access device 108. The AMS 106 may retrieve the ad information 212 from the ad repository 126, which may include ads associated with one or more advertiser 102. The AMS 106 may retrieve relevant ads using information from a crawling module, various statistical associations between ads and content, and/or preference information associated with the publishers.

After receiving the ad information 212, the ad portion 208 displayed by the user access device 108 may populate with ads included in the information 212. For example, the ad portion 208 may populate with ads 225. As illustrated in FIG. 2, the ad portion 208 and the displayed ads 225 may occupy a portion of the content page 204, which may be distinct from other content (e.g., the content 206) presented in the content page 204.

When a user clicks on the displayed ad 225 in the content page 204, an embedded code snippet may direct the user access 108 to contact the AMS 106. During this event, the user access device 108 may receive an information parcel, such as a signed browser cookie, from the AMS 106. This information parcel can include information, such as an identifier of the selected ad 225, an identifier of the publisher 104, and the date/time the ad 225 was selected by the user. This information parcel may facilitate processing of conversion activities or other user transactions.

The user access device 108 is redirected to the advertiser 102 associated with the selected ad 225. The user access device 108 sends a request 214 to the associated advertiser 102 and then loads a landing page 216 from the advertiser 102. The user may then perform a conversion action at the landing page 216, such as purchasing a product or service, registering, joining a mailing list, etc. An advertiser code snippet 218, which may be provided by the AMS 106, may be included within a conversion confirmation page script, such as a script within a web page presented after the purchase. The user access device 108 may execute the advertiser code snippet 218. The advertiser code snippet 218 may contact the AMS 106 and report conversion data 220 to the AMS 106. The conversion data 220 may include conversion types and numbers as well as information from cookies. In some implementations, the conversion data 220 may be maintained in the conversion data repository 136.

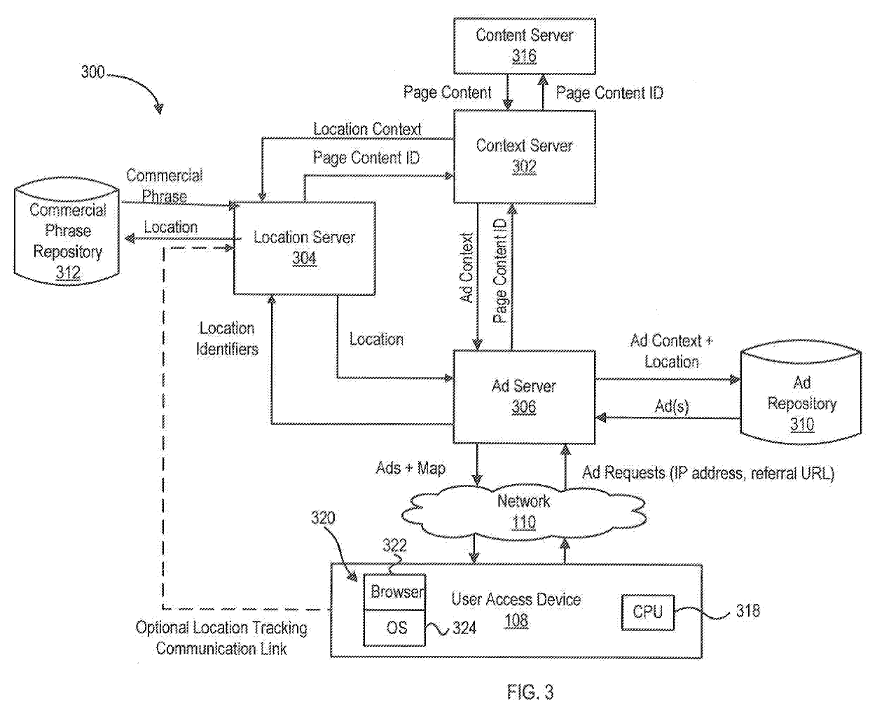

FIG. 3 is a block diagram of an example ad targeting system 300 configured to present location-based commercial information in lieu of on-line advertisements. The ad targeting system 300 includes a context server 302, a location server 304, an ad server 306, an ad repository 310, a commercial phrase repository 312 and a content server 316. The system 300 is one example of an ad targeting system for delivering location-based, content targeted ads and commercial information to end users. Other configurations are possible. For example, the functions provided by the servers shown in FIG. 3 could be performed by a single computer or multiple computers in a network. The servers can be individual server processes run on separate computers or a single server process running on a single computer. The ad repository 310 can include one or more databases located on one or more storage devices, as can the commercial phrase repository 312. The ad server 306 may be an implementation of the data processing system 116 of the AMS 106.

In some implementations, the system 300 can be part of an online publishing tool, such as Google AdSense™ for Content provided by Google. Inc. In other implementations, the system 300 can be part of an online search engine. A user's geographic location may be determined based on direct user input of a geographic location, for example, as part of registering to use the search engine. A user's geographic location also may be determined based on the user's search activity or user's browsing activity. For example, in the event that a user searches for information related to New York City or accesses a web site for a newspaper for New York City, user interest in the geographic location of New York City may be inferred.

In operation, a user access device 108 provides ad requests to the ad server 306. The user access device 108 can be any device capable of presenting advertisements, including but not limited to; personal computers, personal digital assistants (PDAs), mobile phones, smart phones, media players/recorders, game consoles, television systems, electronic tablets, navigation systems, etc. In some implementations, the user access device 108 includes a processor 318 and a computer-readable medium 320 (e.g., memory, hard disk). The computer-readable medium 320 can further include an operating system 324 (e.g., Windows® XP, Linux® OS) and an interface 322 (e.g., a browser). These components can provide connectivity with the ad server 306 through a network 110 (e.g., the Internet, wireless network) and receive and display targeted ads and other information on a display device (not shown) of the user access device 108.

The ad server 306 provides location identifiers to the location server 304. Location identifiers include any information that can be used to determine a geographic location of a user or a location that may be of interest to a user. Some examples of location identifiers include but are not limited to: an Internet Protocol (IP) address, user profiles, user-provided information, access history (such as referral URLs or previously visited web sites or pages), location tracking data, page content, GPS data, cellular position information, broadcast coverage zone or region information, etc.

One way to determine the geographic region of a user, or a region of interest to a user, is to request geographic information from the user. For example, when a user registers on a web site, the user can be prompted, to provide a home or business address. Alternatively, or additionally, an IP address can be used to determine the geographic location of the user. When the user access device 108 contacts the ad server 306 to request a web page, the user access device 108 passes an IP address to the ad server 306. The IP address can be provided by, for example, an Internet Service Provider (ISP). An IP address locator can use the IP address to determine the geographic region of the user. An example of an IP address locator is the IP Address Locator tool developed by Geobytes, Inc.

Referring again to FIG. 3, when a user access device 108 located in, for example, Palo Alto requests an ad from the ad server 306, the ad server 306 receives an IP address with the request which is forwarded to the location server 304. An IP address locator can then use the IP address to access an IP address/location database and retrieve a geographic location associated with the IP address, which in the example is Palo Alto.

In addition to an IP address, the ad server 306 can also receive a referral URL, which is the URL of the page previously visited by the user. When the user access device 108 contacts the ad server 306 to request a web page, the user access device 108 can pass to the ad server 306 the referral URL. In some cases, the referral URL can provide information that can be used to determine the geographic region of the user or a region of interest. For example, if the referral URL was:

“http://www.google.com/search?q=pizza+palo+alto+ca”,

the location server 304 can see that the user used the Google search engine, performed a search for pizza in Palo Alto, Calif., and came to the web page by, for example, clicking on a link on the search engine results page. From this information it can be assumed dud the user is located in Palo Alto or that Palo Alto is a region of interest and that the ad context is pizza.

In some implementations, a service (e.g., a search engine) stores information about the user and the service on the user's system. In some instances, this information is saved in a cookie. If such information includes geographic information, then that information can be potentially used to determine the location of the user.

In some implementations, the location of a user access device 108 can be determined using location tracking technology, such as GPS, radio beacons, Cell-ID, Time of Arrival (TOA), Enhanced Observed Time Difference (E-OTD), etc. In such cases, the user access device 108 can be tracked directly by the location server 304 using location tracking technology.

Another approach for determining the user's location or a region of interest is to examine the content of the web page the user is currently visiting or has visited in the past (e.g., a web page identified in a referral URL). For example, the ad server 306 and/or the location server 304 can send a web page content identifier (ID) to the context server 302. The page content ID is used to retrieve web page content from the content server 316, which can then be analyzed by the content server 302 to determine an ad context or location context based. The result of the analysis (e.g., ad content information) is passed to the ad server 306, which uses the result, together with location information received from the location server 304, to retrieve one or more ads from the ad repository 310.

The context server 302 can include one or more known hierarchical or non-hierarchical clustering algorithms for clustering web pages based on key features or traits (e.g., K-means, agglomerative clustering, QT Clust, fuzzy c-means, Shi-Malik algorithm, Meila-Shi algorithm, group average singles linkage, complete linkage, Ward algorithm, centroid, weighted group average). An example of a suitable clustering method is described in U.S. Provisional Patent Application No. 60/416,144for “Methods and Apparatus for Probabilistic Hierarchical Inferential Learner,” which is incorporated by reference in its entirety,

A clustering algorithm partitions a data set (e.g., a set of web pages) into subsets or “clusters,” so that data in each subset share a common trait or key feature. For example, if a web page includes content related to making pizza, then a clustering algorithm would detect this content (e.g., pizza) and assign the web page to one or more clusters associated with pizza.

Once a web page is assigned one or more clusters, an ad context can be determined based on the assigned clusters. For example, a pizzamakingpros.com web Page may be assigned to a food cluster, a pizza cluster and/or a restaurant cluster, etc. The ad server 306 uses the ad context, together with location information received from the location server 304, to retrieve location based, content targeted ads from the ad repository 310. In some implementations, the ad repository 310 is a relational database (e.g. My SQL™) that can be queried for ads that have a particular ad context and are associated with advertisers having a physical presence in a particular geographic region, such as pizzerias in Palo Alto, Calif.

In some implementations, the ad targeting system 300 could target ads based on search terms or keywords provided by a user, either on a search engine result page, or on a page which is linked from a search engine results page, which contains a targeted advertising display. The search terms can be used to determine the geographic region of the user or a region of interest to the user, as well as the ad context. Search terms can be used with web page content and location identifiers to target relevant ads. The use of search terms to determine a user's location is described in U.S. patent application Ser. No. 11/298,293, for “Determining Advertisements Using User Interest Information and Map-Based Location Information, filed Dec. 9, 2005, Attorney Docket No. GP-680-00-US/Google-142, which is incorporated by reference in its entirety.

When the ad server 306 fails to identify/retrieve one or more ads from the ad repository 310 based on the content of a web page, the ad server 306 may identify/retrieve one or more commercial phrases from the commercial phrase repository 312 based on the location information of a user. The ad server 306 may be unable to identify/retrieve one or more ads from the ad repository 310 based on the content of a web page for various reasons. For example, the clustering algorithm of the context server 302 may fail to assign the web page to one or more clusters, based upon which an ad context may be determined. Even when the web page is assigned to one or more clusters, an ad context may not be determined based on the assigned clusters. Or, although an ad context may be determined based on the assigned clusters, the ad repository 310 may not include any ads corresponding to the determined ad context. In such a ease, the ad server 306 retrieves one or more commercial phrases from the commercial phrase repository 310 based on the location information of the user. The location server 304 may provide the location information of the user.

Additionally or alternatively, the ad server 306 may retrieves one or more commercial phrases from the commercial phrase repository 310 based on the location information of the user. In one example, in the event that an inappropriate ad for the content is determined, one or more commercial phrases based on the location information of the user may be retrieved. In more particular examples, one or more commercial phrases may be determined in lieu of the identified ad when an adults-only ad (such as a risqué ad) is identified for display with content focused for children or when an ad that is offensive to a particular religion is identified for presentation on web site focused on that particular religion.

In some implementations, one or more location-based commercial phrases may be presented in addition to ads identified based on content. For example, advertisers may bid on the placement of location-based commercial phrases. An auction may result in identification of a location-based commercial phrase in addition to, or in lieu of, ads based on content. Additionally or alternatively, techniques that do not involve the use of bids may be used to determine a location-based commercial phrase to be presented. For example, known or estimated Click-Through-Rates (CTR) of commercial phrases may be used to determine a location-based commercial phrase to be presented. In some implementations, the known or estimated CTR values may be combined with advertiser bids to determine a location-based commercial phrase to be presented.

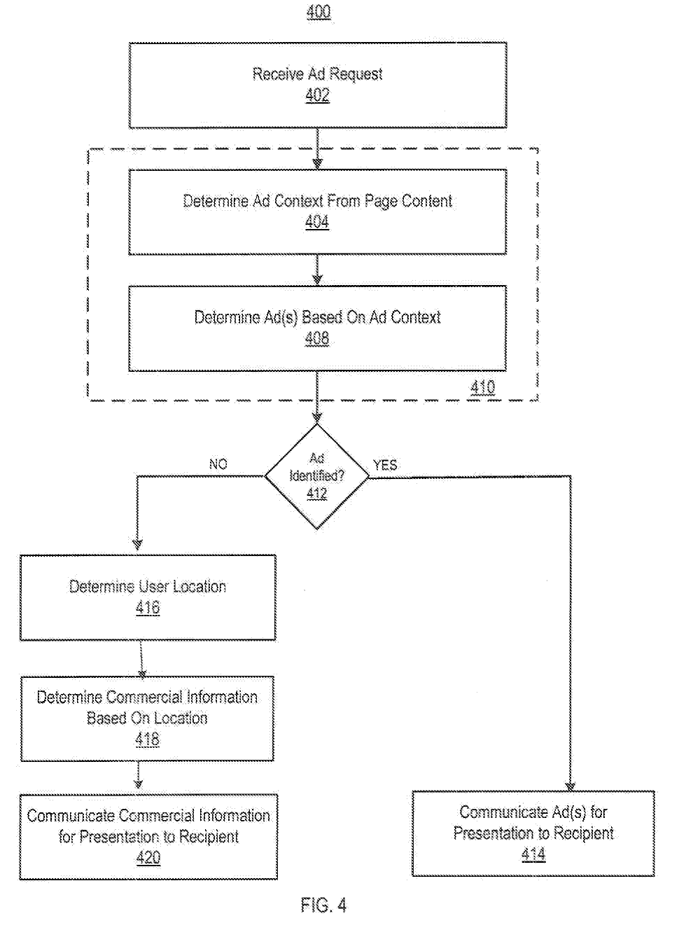

FIG. 4 is a flow diagram of an example ad targeting process 400 configured to present location-based commercial information in lieu of on-line advertisements. The steps of process 400 do not have to occur in a specific order and at least some steps can occur in parallel. The ad targeting process 400 begins when an ad request is received from a user system (402). In some implementations, the ad request can include the URL of the web page which can be crawled by a context server to determine an ad context (404). The webpage can be crawled on a scheduled basis or in response to a trigger event. The context server processes the content using, for example, a clustering algorithm. The clustering algorithm identifies clusters associated with key features or traits that can be used to determine an ad context. If the web page was not previously crawled, the page can he crawled in real-time by a crawler. An example of a crawler is described in Brin, S. and Page, L. (1998), “The Anatomy of A Large-Scale Hypertextual Web Search Engine,” Computer Networks and ISDN Systems, 30(1-2):107-117, which is incorporated by reference herein in its entirety.

Using the ad context, content targeted ads can be retrieved from an ad repository (408). This can be accomplished by determining which ads in the ad repository fall into the ad context. In some implementations, the ad repository is a relational database that can be queried for ads that have a particular ad context, Determining ad context from page content (404) and determining an ad or ads based on ad context (408) may be referred to collectively as a process to identify advertisement information to be presented based on the content.

If ads are identified based on the ad context (412), the ad targeting process 400 proceeds to communicate ads for presentation to a recipient (414).

If ads are not identified based on the ad context (412), the location of the recipient of the ad is determined (416). As explained in connection with FIG. 3, various methods may be used to determine the location of a recipient. Commercial information is determined based on the location of the recipient (418). For example, a list of commercial phrases may be predetermined for each of various locations, such as metropolitan areas or other types of locations to which content is frequently presented (such as, for example, a large university located in a rural area). The list of commercial phases for a location that matches the determined location of the recipient are identified. Alternatively, commercial phrases may be selected from a set of commercial phrases associated with a particular location. The commercial phrases selected may be based, for example, on user interest, a random selection process, or a process that presents subsets of the commercial phrases for the location in a rotating order each time commercial phrases for the location are presented. In other examples, commercial information may include location-based ads that are independent of the content.

The location-based commercial information are then delivered for presentation on a display device (412). The ads may be presented together with the web page requested by the user, for example, as illustrated in FIG. 2.

Various modifications to the ad targeting process 400 may be possible. For example, in some implementations, determining ad(s) based on ad context may include running an ad auction to determine the best N ads, and only those N ads are shown to the user. In some cases, the best N ads could be the top N advertisers, or the top N locations of a given advertiser (e.g., a burger franchise that has 30 locations in New York City). The top N locations can be determined by the distance of each store from a predetermined geographic location, alone or in combination with other factors (e.g., store popularity based on click through rate, page rank).

In some ad auction implementations, only the top x% of ads based on a computed score can be presented, or the position of a given ad in a list of ads can be determined using a score. The score can take into account available information related to geographic location and ad context or advertiser preference. For example, a score could be determined using multiple location indicators (e.g., web page content, IP address, user-provided information, user profiles, referral URLs, GPS data) to determine advertiser locations that are closest to the user. One or more scoring parameters can be weighted to increases or decrease the sensitivity of the score to such parameters.

The ads can be presented to the user, such that the position of the ad in the list is based on the score. For example, higher scoring ads would be at the top of the list. Lower scoring ads would be placed at the bottom of the list. For those ads that are selected for presentation to the user based on a score, an estimated distance and travel time for the advertised locations can be provided.

In another example, the location information of the user may be combined with the ad context to determine ads to be presented to the user. For such implementations, referring to FIG. 4, step 404 may he modified to determine the location information of a user as well as the ad context of the web page requested by the user. Also, step 408 may be modified to use the location information and the ad context to retrieve ads from an ad repository. This may be accomplished by determining which ads fall into the ad context and which advertisers associated with those contextually relevant ads have a physical presence in the geographical location of the user.

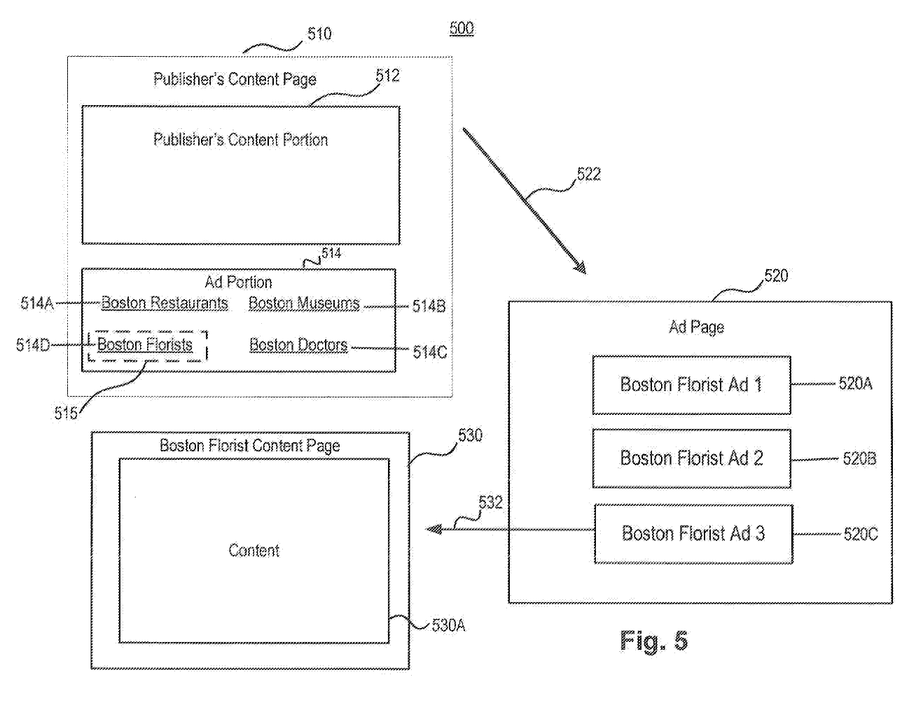

FIG. 5 is a diagram depicting a series 500 of user interfaces 510, 520 and 530 that shows aspects of an on-line advertising system configured to determine location-based commercial information in lieu of ads. In the example of series 500, the user interfaces 510, 520 and 530 are displayed on a user's display device and to a user located in Boston, Mass.

The series 500 includes a user interface 510 displaying a publisher's content page (hereinafter referred to as “publisher's content page”), which may be an implementation of content page 204 described previously with respect to FIG. 2. The publisher's content page includes a content portion 512 and an ad portion 514, which may be implementations of content portion 206 and ad portion 208 of FIG. 2, respectively. The ad portion 514 includes commercial phrases 514A (i.e., “Boston Restaurants”) 514B (i.e., “Boston Museums”) 514C (i.e., “Boston Doctors”) and 514D (i.e., “Boston Florists”). Each of the commercial phrases 514A-%14D are links to other web pages. As shown in the example series 500, commercial phrase 514D is selected by the user, as depicted by the rectangle 515.

Based on the selection of commercial phrase 514D by the user in user interface 510, user interface 520 is displayed on the user's display device (as depicted by arrow 522). The user interface 520 displays an ad page 520 showing three ads for different florists 520A, 520B and 520C each located in the Boston area. The user interface 520 may be an implementation of page 208 described previously with respect to FIG. 2.

Based on the selection of Boston florist 520C, the user interface 530 displaying the home page of the selected Boston florist 520C is presented on the user's display device (as depicted by the arrow 532). The user interface includes content 530A of the home page of the selected Boston florist 520C. The user interface 530 displaying home page of the selected Boston florist 520C may be an implementation of landing page 216 of FIG. 2.

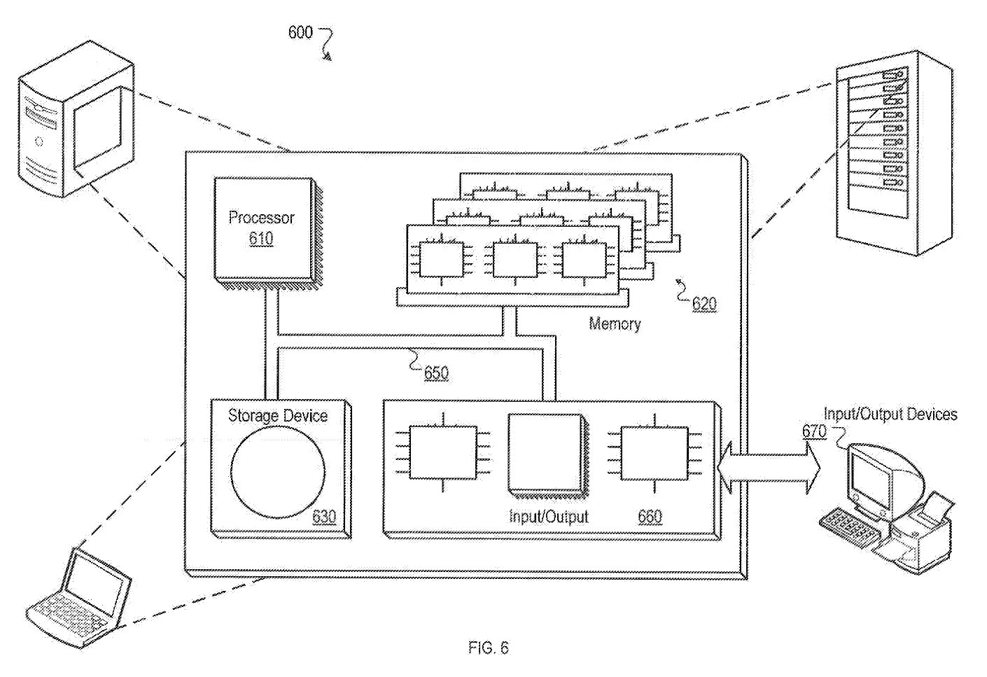

FIG. 6 is a block diagram illustrating an example system architecture for a data processing system, which may implement an element of the ad targeting system 300, for example, an ad server 306. The system architecture 600 includes one or more processors 610, memory 620, storage device 630, input/output 660 and a data bus 650 interconnecting these components. The system architecture 600 may also include one or more network or communication interfaces (not shown).

The input/output interface 600 may provide interface with input/output devices 670. The input/output devices 670 may include input devices, such as a keyboard and mouse, and output devices, such as a display and printer. The input/output devices may be used to administer the date processing system.

Memory 620 or storage device 630 may store an operating system for performing system functions, a network communication module for communicating with other computers or devices through one or more networks and other program modules. For example, if the data processing system 600 implements an ad server 306, memory 630 or storage device 630 may include a program module for retrieving ads from ad repository 310 based on ad context and/or location information of a user.

The disclosed and other implementations and the functional operations described in this description can be implemented in digital electronic circuitry, or in computer software, firmware, or hardware, including the structures disclosed in this specification and their structural equivalents, or in combinations of one or more of them. The disclosed and other implementations can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this description can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks The processor and the memory can be supplemented by, or incorporated in, special purpose logic circuitry.

To provide for interaction with a user, the disclosed technique can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can he interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this description contains many specifics, these should not be construed as limitations on the scope of what being claims or what may be claimed, but rather as descriptions of features specific to particular implementations. Certain features that are described in this description in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination, may be directed to a subcombination or variation of a subcombination.

Similarily, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The techniques and concepts have generally described as presenting location-based commercial information in lieu of ads based on content. The techniques and concepts are generally applicable to presenting location-based commercial information in addition to ads based on content. For example, ads and commercial phrases based on the content viewer's location may be determined and presented to the content viewer.

Thus, particular implementations have been described. Other implementations are within the scope of the following claims.

What is claimed is:

1. A computer-implemented method, comprising:
receiving a request for an advertisement to be presented together with content provided over a delivery network to a recipient;
performing a process to identify advertisement information to be presented based on the content; and
if advertisement information is not identified by the process, identifying commercial information to be presented based on geographic location of the recipient and communicating, over the delivery network, the identified commercial information to the recipient.

2. The method of claim 1 wherein the commercial information comprises text identifying subject matter relevant to the geographic location.

3. The method of claim 2 further comprising providing an option for navigating to one or more advertisements related to the text.

4. The method of claim 3 further comprising providing an option for navigating from one advertisement of the one or more advertisements to content provided by a sponsor of the one advertisement.

5. The method of claim 1 wherein the commercial information comprises an advertisement related to the geographic location.

6. The method of claim 1 wherein performing a process to identify advertisement information to be presented based on the content includes evaluating advertiser bids for placement with content.

7. The method of claim 1 wherein the geographic location of the recipient is determined based on information directly entered by the recipient.

8. The method of claim 1 wherein the geographic location of the recipient is determined based on an IP address.

9. The method of claim 1 wherein the geographic location of the recipient is determined by inferring a geographic location from search activity of the recipient or from browsing activity of the recipient.

10. The method of claim 1 wherein the delivery network includes at least one of a computer network, a telephone network and a broadcast network.

11. A computer-implemented method, comprising;
receiving a request for one or more content items to be presented together with other content, both of which are provided over a delivery network to a recipient;
attempting to identify one or more content items of a first type based, on the other content; and
if the attempt fails, identifying one or more content items of a second type based on a geographic location, of the recipient and communicating, over the delivery network, the identified one or more items to the recipient.

12. The method of claim 11 where the first and the second type are different.

13. The method of claim 11 where the first type is an advertisement and the second type is commercial information.

14. A system comprising;
means for receiving a request for an advertisement to be presented together with content provided over a delivery network to a recipient;
means for performing a process to identify advertisement information to be presented based on the content; and
means for identifying commercial information to be presented based on geographic location of the recipient, if advertisement information is not identified by the process, and communicating, over the delivery network, the identified commercial information to the recipient.

15. A system comprising:
a network interface configured to communicate over a delivery network;
an advertisement identification unit configured to identify advertisement information based on content, upon receiving a request for an advertisement at the network interface unit; and
a commercial information identification unit configured to identity commercial information to be presented based on geographic location of the recipient, if advertisement information is not identified by the advertisement identification unit, and configured to communicate the identified commercial information to the recipient.

16. The system of claim 15 wherein the commercial information comprises text identifying subject matter relevant to the geographic location.

17. The system of claim 16 wherein the commercial information identification unit is further configured to provide an option for navigating to one or more advertisements related to the text.

18. The system of claim 17 wherein the commercial information identification unit is further configured to provide an option for navigating from one advertisement of the one or more advertisements to content provided by the sponsor of the one advertisement.

19. The system of claim 15 wherein the delivery network includes at least one of a computer network, a telephone network and a broadcast network.

20. A computer-readable medium having embodied thereon a computer program, the medium comprising one or more code segments configured to:
receive a request for an advertisement to be presented together with content provided over a delivery network to a recipient;
perform a process to identify advertisement information to be presented based on the content; and
if advertisement information is not identified by the process, identify commercial information to be presented based on geographic location of the recipient and communicate, over the delivery network, the identified commercial information to the recipient.

21. The medium of claim 20 wherein the commercial information comprises text identifying subject matter relevant to the geographic location.

22. The medium of claim 21 where the one or more code segments are further configured to provide an option for navigating to one or more advertisements related to the text.

23. The medium of claim 22 where the one or more code segments are further configured to provide an option for navigating from one advertisement of the one or more advertisements to content provided by the sponsor of the one advertisement.

24. The medium of claim 20 wherein the commercial information comprises an advertisement related to the geographic location.

25. The medium of claim 20 wherein the process to identify advertisement information to be presented based on the content includes evaluating advertiser bids for placement with content.

26. The medium of claim 20 wherein the geographic location of the recipient is determined based on information directly entered by the recipient.

27. The medium of claim 20 wherein the geographic location of the recipient is determined based on an IP address.

28. The medium of claim 20 wherein the geographic location of the recipient is determined by inferring a geographic location from search activity of the recipient or from browsing activity of the recipient.

29. The medium of claim 20 wherein the delivery network includes at least one of a computer network, a telephone network and a broadcast network.

30. A computer-readable medium having embodied thereon a computer program, the medium comprising one or more code segments configured to:
receive a request for one or more content items to be presented together with other content, both of which are provided over a delivery network to a recipient;
attempt to identify one or more content items of a first type based on the other content; and
if the attempt fails, identify one or more content items of a second type based on a geographic location of the recipient and communicating, over the delivery network, the identified one or more items to the recipient.

31. The medium of claim 30 where the first and the second type are different.

32. The medium of claim 30 where the first type is an advertisement and the second type is commercial information.
